(19) United States
(12) Patent Application Publication
(10) Pub. No.: US 2006/0208703 A1
(43) Pub. Date: Sep. 21, 2006

(54) Method & apparatus to provide adaptive variable frequency charging pulses to nickel and SLA battery types

(76) Inventor: John Fee, Garland, TX (US)

Correspondence Address: JACKSON WALKER LLP, 901 MAIN STREET, SUITE 6000, DALLAS, TX, 75202-3797, US

(21) Appl. No.: 11/364,417

(22) Filed: Feb. 27, 2006

Related U.S. Application Data
(60) Provisional application No. 60/656,284, filed on Feb. 25, 2005.
(60) Provisional application No. 60/657,091, filed on Feb. 25, 2005.
(60) Provisional application No. 60/656,285, filed on Feb. 25, 2005.
(60) Provisional application No. 60/656,283, filed on Feb. 25, 2005.

(51) Int. Cl. H02J 7/00

(52) U.S. Cl. 320/131

(57) ABSTRACT

According to one embodiment of the present invention a PLL tracks the charge current frequency and “locks” the voltage frequency to that current frequency

### CLAIM OF PRIORITY

This application claims priority of U.S. Provisional application Ser. No. 60/656,284 filed Feb. 25, 2005, entitled “Method & Apparatus to Provide Adaptive Variable Frequency Charging Pulses to Nickel and SLA Battery Types”; U.S. Provisional application Ser. No. 60/657,091 filed Feb. 25, 2005, entitled “Method & Apparatus to Ensure That Saturation Of the Battery Does Not Occur During Resonant Finding Phase As Well As Implementation Methods To Quickly Find Resonance”; U.S. Provisional application Ser. No. 60/656,285 filed Feb. 25, 2005 entitled “Method and Apparatus to Provide Charging Waveform To Lithium Ion Batteries”; and U.S. Provisional application Ser. No. 60/656,283, filed Feb. 25, 2005, entitled “Method and Apparatus to Provide Prograrnmable Waveform Generator Battery Charger”.

Problem: Today's charging technologies do little to provide charging currents which “match” the battery characteristics. As a result, battery life and charge acceptance are degraded.

### BRIEF DESCRIPTION OF FIGURES

FIG. 1 is a block diagram of a PLL tracking the charge current frequency and associated waveforms; and

FIG. 2 is a block diagram of a digital device tracking the charge frequency.

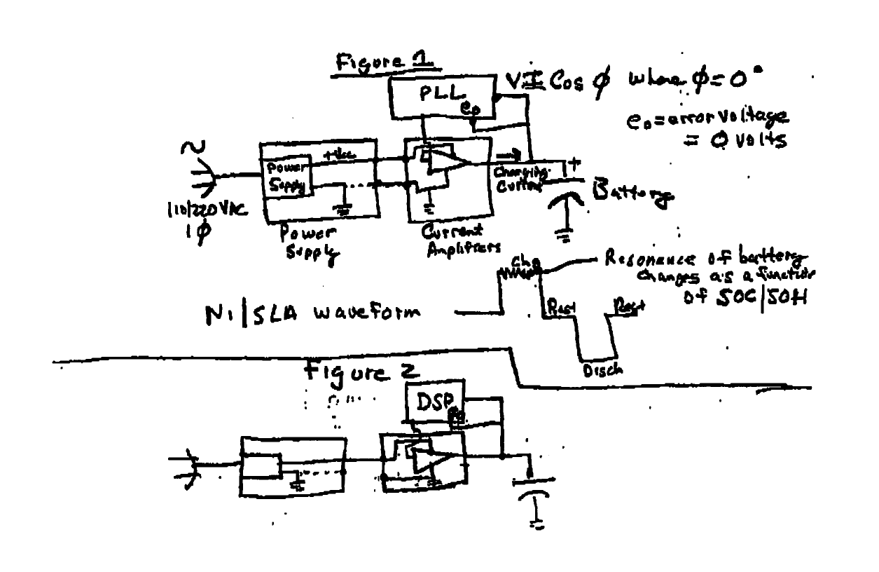

Solution: According to one embodiment of the present invention a PLL tracks the charge current frequency and “locks” the voltage frequency to that current frequency. Typical (Nickel) battery resonances are −5 KHz at 5% SOC and 200 Hz at 100% SOC and decrease monotonically between the two limits. Advantageously, this invention provides the ability for the charger to begin at the 5% (or so) SOC resonance frequency at approximately 5 kHz and reduces the frequency of the charging waveform as a function of increasing SOC. The current (frequency is lowered as the SOC increases) is used as the reference signal and the PLL ensures that the voltage “tracks” the current frequency thereby advantageously ensuring maximum power transfer to the battery (the phasor difference between voltage and frequency are 0). When the battery nears 100% SOC, the invention ensures that the battery is not overcharged. FIG. 1 shows one embodiment and associated waveforms depicting the advantages of this approach.

In another embodiment of the invention, a digital device tracks the charge current frequency and locks the voltage frequency to that current frequency. Today there are many digital devices (DSP, etc) which can perform this function by digital error frequency or voltage. This basic concept of tracking is understood by the ordinary skilled of art. This embodiment is shown in FIG. 2.

Using this invention it has been demonstrated that a Nickel Cd battery can be charged at nearly 1° C. with no degradation in amortization.

We claim:

1. A battery charger adapted to charge a battery as a function of a charge current frequency.
